(19) United States
(12) Patent Application Publication
(10) Pub. No.: US 2016/0027335 A1
(43) Pub. Date: Jan. 28, 2016

(54) FLIGHT TRAINING IMAGE RECORDING APPARATUS

(71) Applicant: Paragon Flight Training Co., Fort Myers, FL (US)

(72) Inventors: Christopher Schoensee, Fort Myers, FL (US); Jeffery M Wolf, Fort Myers, FL (US)

(21) Appl. No.: 14/806,984

(22) Filed: Jul. 23, 2015

Related U.S. Application Data
(60) Provisional application No. 62/028,977, filed on Jul. 25, 2014.

(51) Int. Cl. G09B 19/16

(52) U.S. Cl. CPC G09B 19/165

(57) ABSTRACT

A flight training image recording apparatus includes a housing comprising one or more cameras. The housing and/or separate cameras in a cockpit are mounted in locations to capture images of the pilot, the pilot's hands, the aircraft instrument panel and a field of view to the front of the aircraft. The recorded images are date and time synced along with aircraft location, speed and other telemetry signals and cockpit and control tower audio signals into a multiplexed audio and visual stream. The multiplexed audio and video stream is downloaded either wirelessly to a remote processor or to a portable memory device which can be input to the remote processor. The remote processor displays multiple camera images that are time-stamped synced along with cockpit audio signals and aircraft telemetry for pilot training.

### CROSS REFERENCE TO CO-PENDING APPLICATION

This application claims priority benefit to the Jul. 25, 2014 filing date of co-pending U.S. Provisional Patent Application Ser. No. 62/028,977 for a Flight Training Image Recording Apparatus, the entire contents of which are incorporated herein in its entirety.

### BACKGROUND

The present description relates to airplane flight training and, particularly, to airplane flight training methods and apparatus.

When undertaking flight training to acquire the ability to fly an airplane, a student pilot, must acquire a variety of skills, such as surveying the surrounding environment outside of the airplane, particularly, the intended path of the airplane, a proper hand position on the yoke and constant surveillance of airplane instruments.

Although a flight instructor usually accompanies a student during training, or at least during the initial stages of flight training, the flight instructor is not always in a position to simultaneously see what is in front of the plane, the instrument readings, the student's hand position on the yoke, as well as where the student's eyes are directed.

Since successful flight training requires mastery of all of these skills, it is desirable to provide a flight training method and apparatus which is capable of recording for subsequent display video images, audio communications and aircraft telemetry during a flight training session.

### SUMMARY

A flight training image recording apparatus includes a plurality of cameras arranged along different image recording axes in an aircraft, each camera generating recorded images. The cameras transmit the recorded images to a data acquisition unit. The data acquisition unit includes a processor executing program instructions and use a time stamp to synchronize the images.

The plurality of cameras may be mounted in a single housing mountable in an aircraft interior.

Each camera can be coupled to a wireless transmitter for transmitting the recorded images remotely to an image receiver coupled to the data acquisition unit.

At least one audio sensor can be mountable in an aircraft cockpit to record audio communications within the cockpit.

The audio sensor is coupled to the data acquisition unit for communicating the audio communications to the data acquisition unit. The data acquisition unit time-stamps the audio signals.

A data transfer medium is used to transfer aircraft telemetry signals relating to at least one of aircraft operating characteristics, GPS location, altitude, aircraft speed, and accelerometer output, the audio communications and the recorded images from the processor. The data transfer medium can be a flash memory card, or a wired or wireless connection to a portable computing device.

A remote processor remote from the aircraft is coupled to a display capable of displaying video images and/or telemetry signals.

The remote processor accepts an output of the data transfer medium and communicates the recorded images from the plurality of cameras to the display for simultaneous display of some or all of the recorded images from the plurality of cameras in a time-stamped synchronized manner.

A method of training a pilot in the operation of an aircraft includes: Arranging a plurality of cameras along different image recording axes in aircraft interior; communicating the images recorded by each of the plurality of cameras during operation of the aircraft to a data acquisition unit; and transmitting recorded images from the data acquisition unit to a remote processor executing control instructions stored in a memory, the processor displaying the recorded images in time synchronization simultaneously on a display.

The method may include mounting the plurality of cameras in a single housing mountable in an aircraft interior.

The method may include wirelessly transmitting the images recorded by the plurality of cameras to a receiver coupled to the processor.

The method may include mounting at least one audio sensor in an aircraft cockpit to record audio communications within the cockpit; coupling the audio sensor to the data acquisition unit for communicating the audio communicating to the data acquisition unit; and the data acquisition unit time-stamping the audio by communications.

The method may include providing a data transfer medium for transferring aircraft telemetry signals relating to at least one of aircraft operating characteristics, GPS location, altitude, aircraft speed, and accelerometer output, the audio communications and the recorded images.

The method may include providing a processor remote from the aircraft executing program instructions, the remote processor coupled to a display capable of displaying video images, and accepting by the remote processor an output of the data transfer medium communicating the recorded images from the plurality of cameras communicated by the data transfer medium to the display for simultaneous display of one or more of the recorded images from the plurality of cameras in a time-stamped synchronized manner

### DETAILED DESCRIPTION OF THE DRAWING

The various features, advantages and other uses of the present Flight Training Image Recording Apparatus will become more apparent referring to the following detailed description and drawing in which:

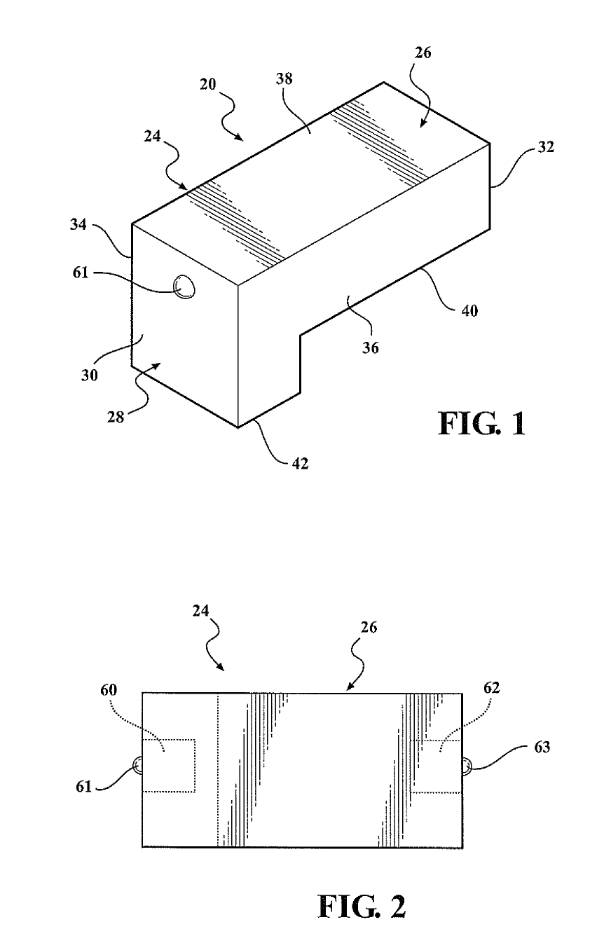

FIG. 1 is a perspective view of one aspect of a flight training apparatus housing mountable in an airplane;

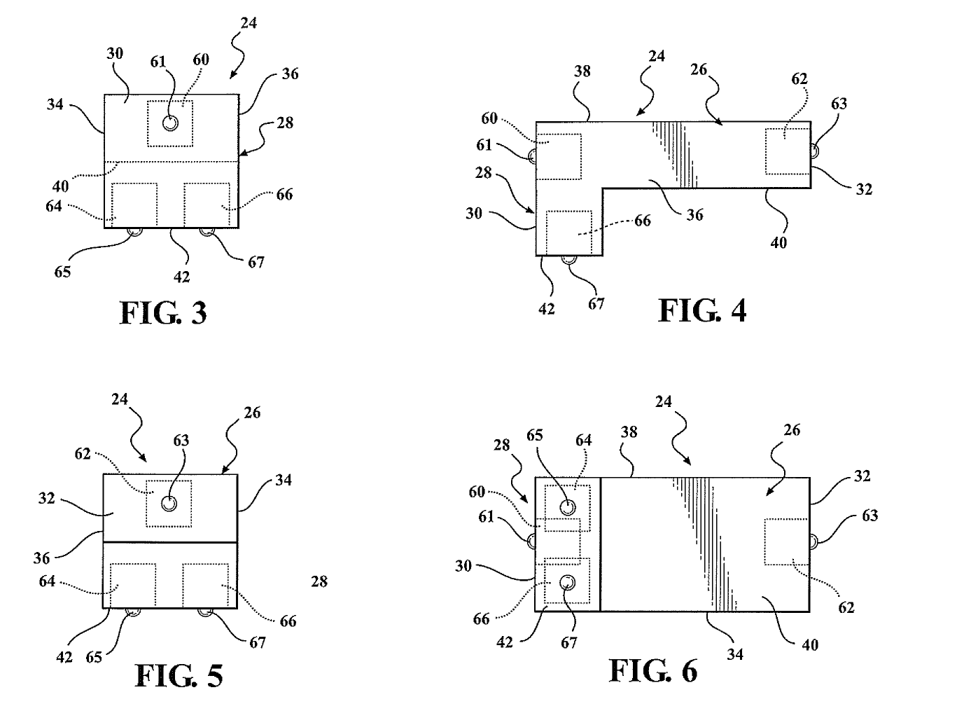

FIGS. 2-6 are orthographic views of the housing shown in FIG. 1 and respectively show a plan view, a front view, a right side view, a rear view, and a bottom view of the housing;

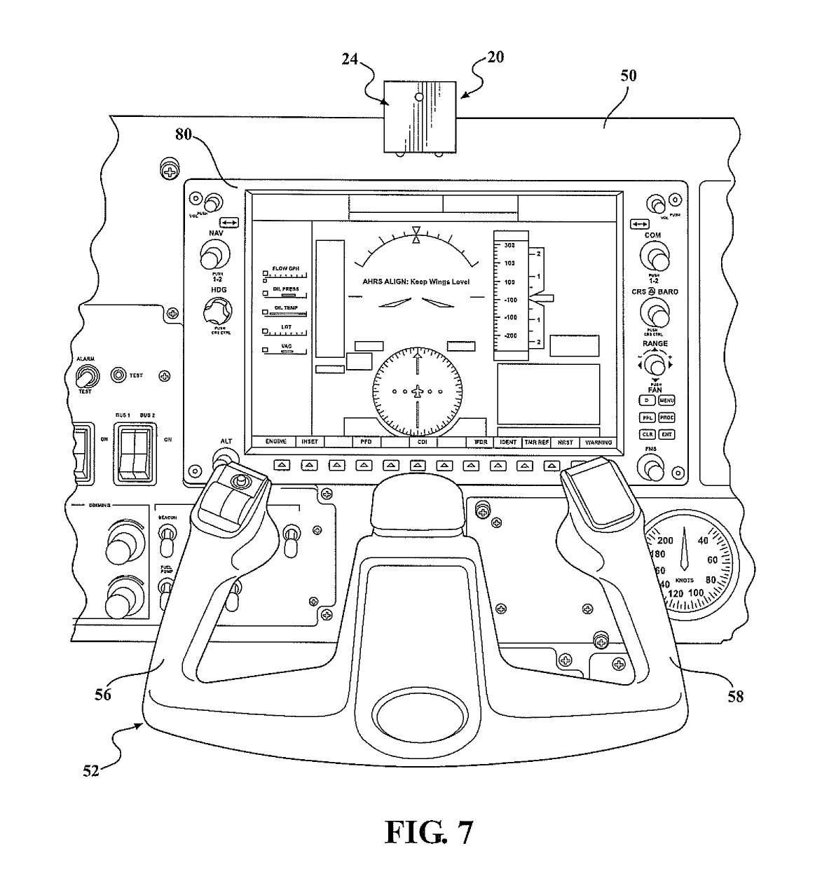

FIG. 7 is a pictorial representation of an aircraft cockpit depicting the mounting position of the housing shown in FIGS. 1-6;

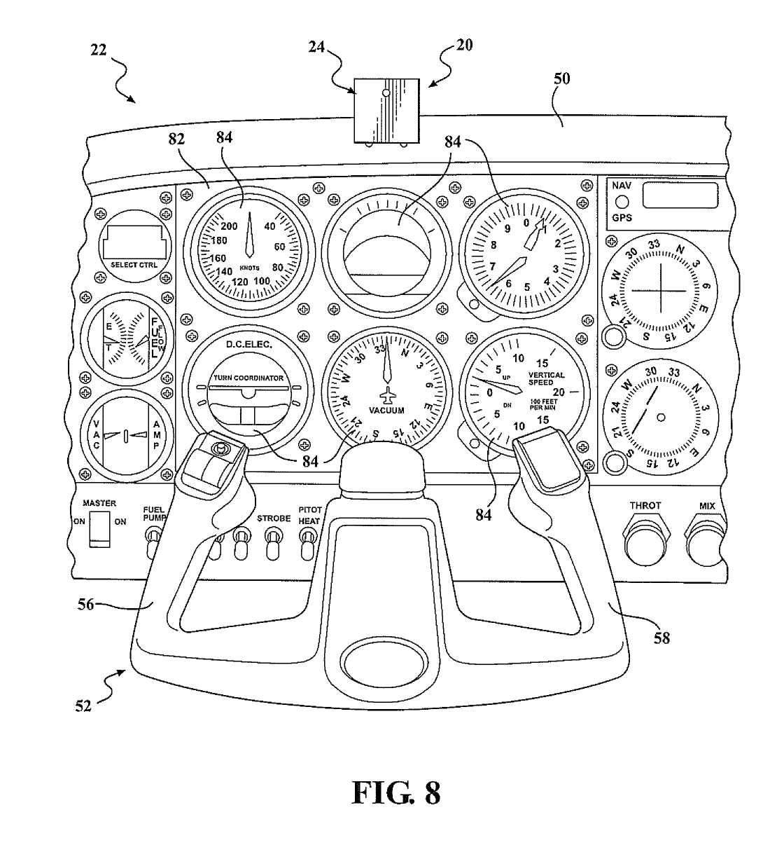

FIG. 8 is a pictorial representation of a different aircraft cockpit also depicting the mounting position of the housing shown in FIGS. 1-6;

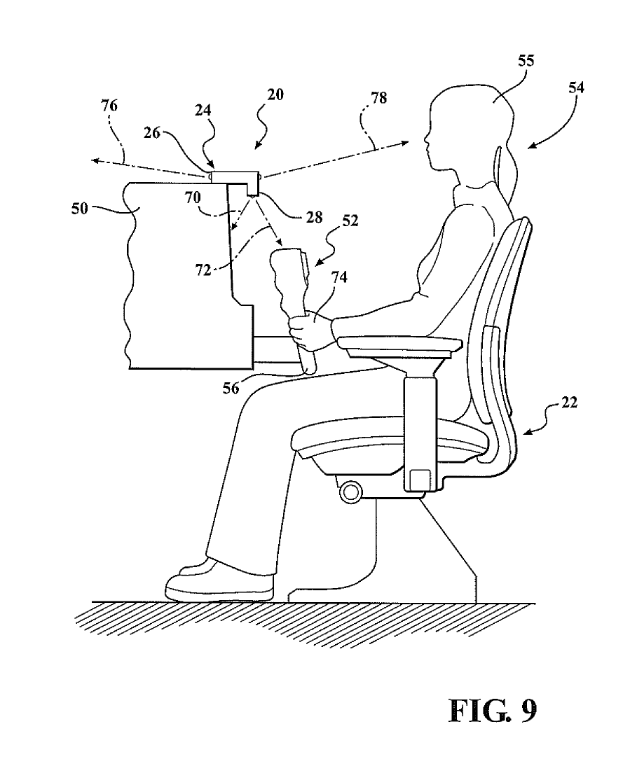

FIG. 9 is a side elevational view showing the camera image axes from the housing with respect to the aircraft, the aircraft dashboard, and the pilot;

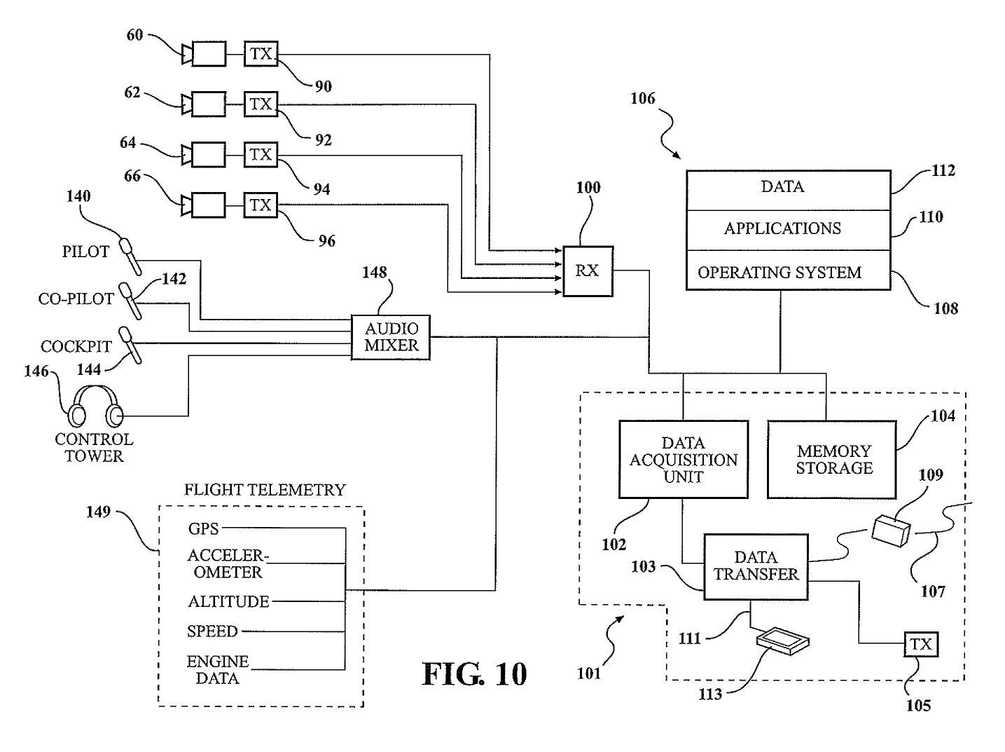

FIG. 10 is a schematic block diagram showing the connections of the operative components of the flight training image recording apparatus;

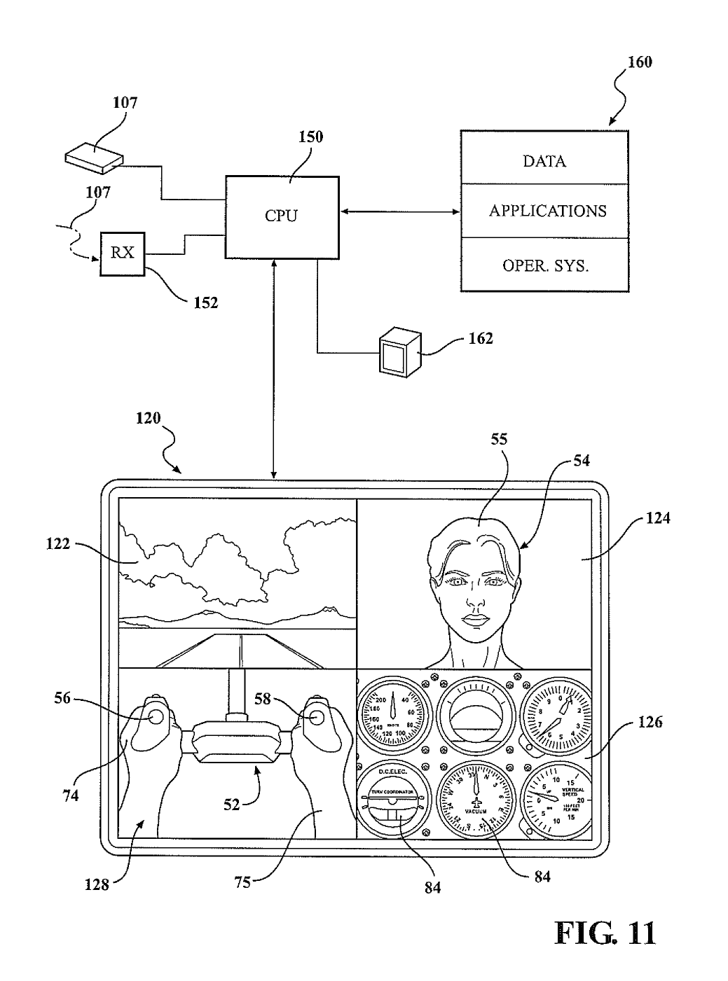

FIG. 11 is pictorial representation of a display showing multiple time synced images recorded by the cameras in the housing during the flight of an aircraft; and

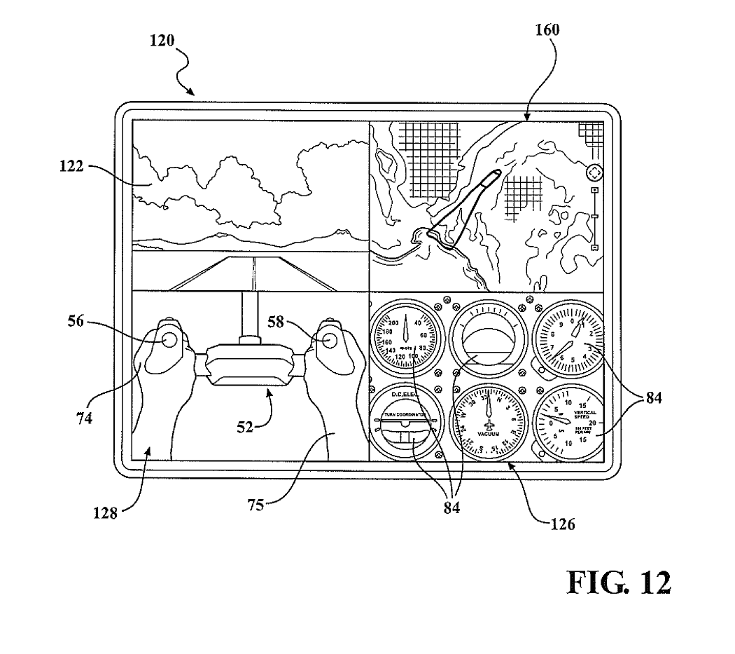

FIG. 12 is a pictorial representation of the display showing another aspect of the displayed images.

### DETAILED DESCRIPTION

Referring now to FIGS. 1-12 of the drawing, there is depicted an apparatus for training a student pilot on the operation of aircraft (used interchangeably with airplane) in the form of a flight training image recording apparatus and method, the aircraft and the aircraft controls for recording for subsequent display images of various attitudes and positions of a student, the aircraft, and the aircraft controls during a flight training session to facilitate training and the proper control techniques of an aircraft during flight. The apparatus and method uniquely records images of various parts of the student's body and position, such as the student's eyes and the student's hands as well as the environment outside of the airplane in the intended path of movement of the airplane and as well as the airplane instruments. These images are recorded for subsequent display on a suitable computing device, tablet computer, laptop, desktop, or smart phone, whereby the multiple recorded images synchronized in time or with audio and flight telemetry, can be simultaneously displayed for student flight training purposes to enable a flight trainer and, more particularly, the flight student, to easily see what was ahead of the airplane, where the student's eyes were directed, the instrument readings and the position of the student's hands on the airplane yoke at each instant of time.

The apparatus 20 includes a body 24 carrying one or more image recording devices or sensors, such as CCD cameras. The body 24 is configured for mounting at a convenient location in an airplane cockpit 22, shown in FIGS. 8 and 9, so as to provide simultaneous, time synchronized images of various portions of the airplane cockpit and the student's body position to facilitate proper flight training.

In one example, the body 24 has an L shape formed of a long length portion 26 and an angularly disposed, such as perpendicularly disposed, smaller length portion 28. The body 24 is configured to carry one or more cameras, only the lens of which is shown in the drawings. The cameras, while mounted in the housing have their lens directed in different directions or axes, as will be described hereafter.

It will be also be understood that while multiple cameras can be mounted in the body 24, separate housings or even just separate cameras may be mounted at different locations in the airplane cockpit. Such cameras may be hardwired to the body 24 or the data acquisition unit described hereafter. Such cameras may also communicate video images wirelessly by a Bluetooth or other video transmission format to the data acquisition unit.

The body 24 is formed of a suitable material, such as metal, plastic, etc. The body 24 can be formed of a one piece body with a first endwall 30, and opposed second endwall 32, opposed sidewalls 34 and 36, a first outer wall 38, a second outer wall 40 extending along the longer length portion 26, and a shorter third opposite wall 42 at one end of the shorter length portion 28.

The body 24 is fixedly or removably attachable to a convenient part of the airplane cockpit, such as the dashboard 50 shown in FIGS. 8 and 9. By example only, the body 24 can be mounted on the dashboard 50 by releasable fasteners, such as Velcro, clamps, clips, etc. This allows the body 24 to be removed from the housing when there is no longer a need for flight training. When Velcro is employed, one Velcro hook or pile strip may be adhesively secured to the second outer wall 40 or the longer length portion 26 of the body 24 for releasable engagement with a mating Velcro loop or hook strip adhesively mounted on an outer surface of the airplane dashboard 50, centered on the center line of the airplane yoke 52 between the spaced arms 56 and 58, as well as being centered on a vertical center line through the flight trainee's head 55.

Multiple cameras, such as four cameras 60, 62, 64, and 66, for example, are mounted, either permanently or removably, within the body 24, through a non-shown openable closure member or door which can be mounted on the second outer wall 40 of the longer length portion 26 of the body 24. Suitable mounts, also not shown, may be formed in the interior of the body 24, for snap in or other stationary mounting of the cameras 60, 62, and 66 in the body 24.

As shown in FIGS. 1-6, the camera 60 is mounted behind the first endwall 30 of the body 24 with its lens 61 facing outward of the first endwall 30.

The camera 62 is mounted in the body 24 with its lens 63 facing outward from the opposed second endwall 32.

Two cameras 64 and 66 are mounted in the shorter length portion 28 of the body 24 with the respective lens 65 and 67 facing exteriorly of the third wall 42. The cameras 64 and 66 and/or the lens 65 and 67 are located along different image recording axes so that when the body 24 is mounted on the dashboard 50, the lens 65 for the camera 64 is mounted along a viewing axis 70 which extends toward the instrument panel of the airplane. Similarly, the lens 67 of the camera 66 is oriented to extend along axis 72 which is directed toward the yoke 52 for obtaining an image of the placement of the trainee's hands 74 and 75 on the yoke arms 56 and 58.

Similarly, the camera 60 and its lens 61 are oriented along a viewing axis 76 extending ahead of the airplane through the airplane windshield to obtain an image of the exterior environment to the front of the airplane. The camera 62 and its lens 63 are oriented along axis 78 which is directed toward the trainee's head 55 seated in the airplane cockpit.

FIG. 7 depicts one example of an airplane instrument panel 80, which is in the form of a display panel capable of displaying multiple airplane instruments readings, either one at a time or simultaneously through pilot selection.

FIG. 8 depicts an alternate example of an airplane instrument panel 82, which contains of plurality of separate instruments 84, each depicting a different airplane operating characteristic, such as heading, compass, speed, etc.

As shown in FIG. 10, the cameras 60, 62, 64, and 66, which could be hardwired to a single transmitter unit, can also be hardwired to separate transmitters 90, 92, 94, and 96, respectively. The transmitters 90, 92, 94 and 96 are coupled to a receiver 100, either through separate hardwire connections or by wireless signal communication using conventional wireless signal formats.

The receiver 100 is coupled to a data acquisition unit (DAU) 102 including a bus connected processor or (CPU), which also may in the form of multiple CPU's and a memory 106 capable of storing the operating system 108 of the CPU, various application programs 110, as well as data 112, and additional memory storage 104.

The images from the transmitters 90, 92, 94, and 96 can be transmitted wirelessly and remotely from the airplane through satellite communication a cellular network, etc., to the receiver 100. This allows the images to be recorded by the DAU 102 and stored in memory 104 and/or 106 simultaneously with the capture or recording of the images by the cameras 60, 62, 64, and 66.

The DAU 102 can transmit the captured images through a data transfer medium 103 forming part of the overall flight training recording apparatus. The data transfer medium 103 can include a transmitter 105 capable of wirelessly transmitting the images and other audio/video or telemetry signals remotely from the aircraft to a remote located processor as described hereafter. Alternately, the images from the cameras 60, 62, 64, and 66 and/or other audio and telemetry signals can be transmitted to a local memory device, such as a flash card memory, removably connected to the DAU 102 in the airplane for recordation. The flash memory card, such as a USB, SD card, etc., once the image transfer has been completed, such as at the end of a training flight, can be removed from the DAU 102 and transported to and inserted into the remote CPU for subsequent display of the recorded images and other flight telemetry and audio signals.

As shown in FIG. 10, the data transfer medium 103 can also include a removable wired connection 111, such as an Ethernet cable, to a portable computer or tablet computer 113 containing a processor and memory as well as an operating system and application, as described hereafter for the processor 150 shown in FIG. 11 which enables the portable computer or tablet computer 113 to display one or more of the images as described hereafter to aid the student pilot in flight training. The data transfer medium 103 for the portable computer or tablet computer 113 may also include the use of a transmitter 105 and a wireless connection from the DAU 102.

The portable computer or tablet computer 113 can also be used to retransmit the video images, audio communications and aircraft telemetry stored in memory to the remote processor 150, as described hereafter.

As described above, the images from the cameras 60, 62, 64, and 66 are time synchronized by the DAU 102 so that at a particular instance of image recordation, multiple images, with four images being generated by the example of the use of four cameras 60, 62, 64 and 66 are generated at the same day and time and provided with the same time stamp.

Additional information, such as audio communications and aircraft telemetry, may also be input to the DAU 102 and time-stamped in coordination with the recorded images from the cameras 60, 62, 64 and 66. In one aspect, audio signals from the aircraft cockpit are acquired by one or microphones 140, 142 and 144 or by the pilot or co-pilot headphones 146. Such microphones 140, 142 and/or 144 may be removably or fixedly mounted at selected locations in the aircraft cockpit or the microphones 140 and 142 may be the pilot and co-pilot's headset microphone. Likewise, audio communication from the control tower received by the pilot and/or co-pilot's headphones 146 may also be recorded.

The DAU 102 functions to synchronize all input telemetry data from the aircraft, such as audio, engine operating data, aircraft attitude, avionics data and camera images, to enable all or any portion of such telemetry data, images and audio communications to be presented to the student at any selected time interval during a review of the overall flight time. The DAU 102 also enables telemetry data, such as attitude, altitude, GPS, etc., to be produced via separate attitude, altitude, GPS sensors coupled to the DAU, when it is not possible obtain such telemetry data from the aircraft avionics equipment. The DAU 102 synchronizes in a timestamped manner, all telemetry data, including audio communications, video images and aircraft telemetry, in a synchronized manner to produce a seamless information flow for presentation to the student pilot.

The audio signals from the microphones 140, 142 and 144 and the headphones 146 are input to an audio mixer 148 which records and combines the audio signals from any of the microphones 140, 142 and 144 and the headphones 146 into an audio data stream which is transmitted by hardwire or wireless signal communication to the DAU 102. Such audio signals also include a time stamp for later synchronization by the DAU 102 with the camera images.

In another aspect, flight telemetry can also be recorded and time-stamped with the audio and video information by the DAU 102. Such flight telemetry can include, for example, the GPS location of the aircraft, an accelerometer output showing pitch and yaw of the aircraft, altitude, speed and other selected aircraft engine operating data. Such flight telemetry can be acquired by individual sensors coupled to the appropriate aircraft operating system or separate stand-alone sensors, such as a separate GPS or accelerometer sensor, wirelessly or hard-wired connected to the DAU 102. Alternately, such flight telemetry can be acquired directly from the main control computer system or from the instrumentation of the aircraft. Time-stamped information is added to the flight telemetry, on a continuous or periodic basis for synchronization with the video and audio signals acquired by the DAU 102.

The display 120, shown in FIG. 11, can be a display or monitor coupled to a central processor (CPU 150) based computer system, such as a desktop computer, laptop computer, and tablet or smartphone network, for viewing after the trainee 54 has completed a flight training session. The CPU 150, and other data, can be directed through suitable inputs via a keyboard, touchscreen, etc., to select and sequentially display all or a portion of the images throughout a training session, select any particular sequence of images, such as images associated with a takeoff, a turn, a landing, changing altitude, etc., along with the accompanying audio and telemetry.

The CPU 150 communicates with the memory 160 which stores image data, applications and an operating system. The CPU 150 executes control or program instructions to receive the video, audio and telemetry data from the portable memory card 107 or from the receiver 152, all which have been synchronized and time-stamped by the DAU 102.

Four images 122, 124, 126, and 128 can be generated simultaneously in a quadrant like arrangement shown by example in FIG. 11. This allows the trainee and/or the flight instructor to review the exact conditions at a particular instant of a flight training session. Images, such as image 122, shows the environment in front of the airplane in the intended path of movement of the airplane. Image 124 shows the eyes of the trainee. Image 128 shows the position of the trainee's hands 74 and 75 on the arms 54 and 56 of the yoke 52. Image 126 depicts the instrument panel gauges or display 84.

In conjunction with the displayed images 122, 124, 126, and 128, the positions of which can be moved to different locations on the display 120 or presented in one, two, three, four, or more images displayed at one time on the display 120 or in multiple images on two or more side-by-side positioned displays, audio communication from any or all of the microphones 140, 142 and 144 and the control tower signals from the pilot's headphones 146 can also be broadcast by a speaker or speakers 162 coupled to the CPU 150.

Any one or more of the images 122, 124, 126 and 128 may be replaced by digital display of selected flight telemetry 149. Alternately, the flight telemetry may be superimposed over the respective instruments 84 shown in the video image 126.

FIG. 12 depicts another view of the display 120 in which one of the images, such as the image of 124, for example, is replaced by a map image showing the training flight plan or the location of the aircraft with respect to the ground throughout the training flight. The image 160 can replace any of the images 122, 124, 126 and 128 or be enlarged to fill the complete display screen.

As with the images 122, 124, 126 and 128 as shown in FIG. 11, the application program executed by the processor 150 can select a single image 122, 124, 126 or 128 for display at a particular time instance during the training flight, two, three, four or more images simultaneously in any position on the display 120, provide for relocation of any of the images 122, 124, 126 and 128 at any position on the display 120.

As all of the images 122, 124, 126 and 128 are time stamped, the images show the different conditions and trainee attitude and body position, including eye and hand positions at the same time instance. This allows both the trainee and the flight instructor to determine if the trainee's eyes were directed in the proper direction toward to the front of the plane, or toward the instruments or display 84, as well as whether the trainee's hands 74 and 75 where in the proper position on the arms 54 and 56 of the yoke 52 to execute a maneuver and that the trainee moved the yoke 52 properly to execute a maneuver.

What is claimed is:

1. An apparatus for training a pilot in aircraft operation comprising:
a plurality of cameras arranged along different image recording axes in an aircraft, each camera recording images;
the cameras transmitting the recorded images to a data acquisition unit;
a data acquisition unit including a processor executing program instructions; and
the processor time-stamping the recorded images to synchronize the recorded images.

2. The apparatus of claim 1 wherein:
the plurality of cameras are mounted in a single housing mountable in an aircraft interior.

3. The apparatus of claim 1 wherein:
each camera coupled with a wireless signal transmitter for transmitting recorded images remotely to a signal receiver coupled to the data acquisition unit.

4. The apparatus of claim 1 further comprising:
at least one audio sensor mountable in an aircraft cockpit to record audio communications within the cockpit;
the audio sensor coupled to the data acquisition unit for communicating the audio communications to the data acquisition unit; and
the data acquisition unit time-stamping the audio signals.

5. The apparatus of claim 1 further comprising:
a data transfer medium for transferring aircraft telemetry signals relating to at least one of GPS location, altitude, aircraft speed, and accelerometer output aircraft operating characteristics.

6. The apparatus of claim 1 further comprising:
at least one audio sensor mountable in an aircraft cockpit to record audio communications within the cockpit;
the audio sensor coupled to the data acquisition unit for communicating audio signals to the data acquisition unit;
the data acquisition unit time-stamping the audio signals;
a data transfer medium for transferring aircraft telemetry signals relating to at least one of GPS location, altitude, aircraft speed and accelerometer output aircraft operating characteristics; and
the data acquisition unit time-stamping all audio communications and aircraft telemetry signals.

7. The apparatus of claim 1 further comprising:
a processor remote from the aircraft executing program instructions, the remote processor coupled to a display capable of displaying video images;
the remote processor accepting an output of the data transfer medium and communicating the recorded images from the plurality of cameras communicated by the data transfer medium to the display for simultaneous display of all of the recorded images from the plurality of cameras in a time-stamped synchronized manner.

8. The apparatus of claim 7 wherein:
the data transfer medium is a flash memory card.

9. The apparatus of claim 7 wherein the data transfer medium comprises:
a transmitter coupled to the processor of the data acquisition unit for wirelessly transmitting the recorded images from the plurality of cameras; and
a receiver coupled to the remote processor for receiving the transmitted recorded images from the processor of the data acquisition unit.

10. The apparatus of claim 7 wherein;
the data transfer medium is a communication connection to a processor based portable computer.

11. A method for training a pilot in the operation of an aircraft comprising:
arranging a plurality of cameras along different image recording axes in an aircraft interior;
communicating the images recorded by each of the plurality of cameras during operation of the aircraft to a data acquisition unit; and
transmitting recorded images from the data acquisition unit to a remote processor executing control instructions stored in a memory, the processor displaying the recorded images in time synchronization simultaneously on a display.

12. The method of claim 11 further comprising:
mounting the plurality of cameras in a single housing mountable in an aircraft interior.

13. The method of claim 11 further comprising:
wirelessly transmitting the images recorded by the plurality of cameras to a receiver coupled to the processor.

14. The method of claim 11 further comprising:
displaying at least two of the images with the same time stamp synchronization simultaneously on a display.

15. The method of claim 11 further comprising:
mounting at least one audio sensor in an aircraft cockpit to record audio communications within the cockpit;
coupling the audio sensor to the data acquisition unit for communicating the audio communicating to the data acquisition unit; and
the data acquisition unit time-stamping the audio by communications.

16. The method of claim 11 further comprising:
providing a data transfer medium for transferring aircraft telemetry signals relating to at least one of aircraft operating characteristics, GPS location, altitude, aircraft speed, and accelerometer output.

17. The method of claim 11 further comprising:
mounting at least one audio sensor in an aircraft cockpit to record audio communications within the cockpit;
coupling the audio sensor to the data acquisition unit for communicating audio communications to the data acquisition unit;
time-stamping the audio communications by the data acquisition unit;
providing a data transfer medium for transferring aircraft telemetry signals relating to at least one of aircraft operating characteristics, GPS location, altitude, aircraft speed and accelerometer output; and
by time-stamping all audio communications and aircraft telemetry signals.

18. The method of claim 11 further comprising:
providing a remote processor remote from the aircraft executing program instructions, the remote processor coupled to a display capable of displaying video images; and
accepting by the remote processor an output of the data transfer medium and communicating the recorded images from the plurality of cameras communicated by the data transfer medium to the display for simultaneous display of all of the recorded images from the plurality of cameras in a time-stamped synchronized manner.

19. The method of claim 18 comprising:
forming the data transfer medium as a flash memory card.

20. The method of claim 18, wherein the data transfer medium comprises:
coupling a transmitter to the processor of the data acquisition unit for wirelessly transmitting the recorded images from the plurality of cameras; and
coupling a receiver to the remote processor for receiving the transmitted recorded images from the processor of the data acquisition unit.
